(19) United States
(12) Patent Application Publication
(10) Pub. No.: US 2005/0237609 A1
(43) Pub. Date: Oct. 27, 2005

(54) Binoculars

(75) Inventors: Satoru Nemoto, Saitama-ken (JP); Ken Hirunuma, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/109,697

(22) Filed: Apr. 20, 2005

(30) Foreign Application Priority Data
Apr. 21, 2004 (JP) 2004-125911

(51) Int. Cl. G02B 23/00; G02B 27/64

(52) U.S. Cl. 359/410; 359/407

(57) ABSTRACT

Binoculars include a pair of observation optical systems each having an objective optical system, an erecting optical system and an eyepiece optical system, and a focusing mechanism that moves a part of each of observation optical systems. A convergence value compensating mechanism is provided, which operates in association with operation of the focusing mechanism, to move displaceable optical elements, which are at least a part of one of the pair of objective optical systems, to compensate for the convergence value. Corresponding optical elements of the other one of the pair of objective optical systems are not moved and does not contribute to vary the convergence value.

### BACKGROUND OF THE INVENTION

The present invention relates to binoculars.

When an object at infinity is observed by a pair of binoculars, a field of view observed by a left eye of an observer and a field of view observed by the right eye substantially overlap each other, and a single field of view is observed when the observer observes the binoculars with both eyes. When an object at a relatively short distance of several meters or less is observed with the binoculars, only a part of the field of view for each of the right eye and left eye overlaps each other, and the observer feels difficulty in observing such an object. This is because, in binoculars, the optical axes of left and right objective lenses are generally fixed to be parallel to each other since the binoculars are generally designed to observe an object located within a range from several tens of meters to infinity. If an object at a short distance is observed with such binoculars, a remarkable discrepancy arises between a focusing condition corresponding to the object (which will be referred to as an adjustment value, i.e., a distance to an object to be focused, for example, represented by a unit of diopter [dptr]=[1/meter]) and convergence value (which is a distance at which a right sight line and a left sight line cross, for example, represented by metric angle [MW]=[1/meter]). When an object is observed at high magnifying power, an influence due to such discrepancy is remarkable. For example, with ten-power binoculars, the degree of discrepancy is ten times in comparison with the degree of discrepancy of naked eyes. The remarkable discrepancy between the adjustment value and convergence value is a burden to the eyes of the observer and causes the eyes to be fatigued. (It should be noted that the term “convergence” means the visual axes of both eyes which are concentrated when observing an object at a short distance, and the angle formed between both axes is referred to as a “convergence angle”).

In view of the above-described problem, in order to reduce the burden to the eyes when observing an object at a short distance, binoculars provided with a convergence value (convergence angle) compensating mechanism have been developed. In such binoculars, in accordance with the adjustment value, the convergence value (or convergence angle) is adjusted by moving both objective lenses in the direction orthogonal to the optical axes thereof to make the objective lenses located close to each other when observing an object at a short distance. Examples of such binoculars are disclosed in Japanese Patent Publications No. 3090007, No. 3196613 and Japanese Patent Provisional Publication No. HEI 05-107444.

However, the structure of a convergence value compensating mechanism of the binoculars described in each of the patent publications is relatively complicated. That is, according to the conventional mechanism, a mechanism for moving an objective lens in a direction perpendicular to the optical axis thereof should be provided for each of the right and left objective lenses. Therefore, the mechanism is complicated, and further, the number of elements is increased, which increases a manufacturing cost of the binoculars.

Further, when moved in the direction perpendicular to the optical axes thereof, both the right and left objective lenses should be moved in complete association with each other. However, it is difficult to realize a sufficient accuracy in such a mechanism, and even if manufactured accurately, it may easily be deteriorated with age.

### SUMMARY OF THE INVENTION

The present invention is advantageous in that binoculars capable of compensating for the convergence value with a relatively simple structure but at a high accuracy in accordance with an adjustment value when observing an object at a short distance are provided.

According to an aspect of the invention, there is provided binoculars which include a pair of observation optical systems each having an objective optical system, an erecting optical system and an eyepiece optical system, a focusing mechanism that moves a part of each of observation optical systems, a convergence value compensating mechanism that operates in association with operation of the focusing mechanism, the convergence value compensating mechanism moving displaceable optical elements which are at least a part of one of the pair of objective optical systems to compensate for the convergence value, optical elements of the other one of the pair of objective optical systems being unmoved for varying the convergence value.

Optionally, the convergence value compensating mechanism may be configured to move the displaceable optical elements such that a distance between an optical axis of one of the pair of objective optical systems and the other one of the pair of objective optical systems varies in association with the movement of the part of each of observation optical systems for focusing.

In a particular case, the convergence value compensating mechanism may be configured to rotate the displaceable optical elements about a line parallel with the optical axis thereof to vary the distance between the optical axis of the optical element and the optical axis of the other one of the pair of objective optical systems.

Optionally, the focusing mechanism may move at least a part of an element of each of the pair of objective optical systems for focusing, and the convergence compensating mechanism may be provided with a guiding mechanism that guides the movement of the displaceable optical elements to rotate about the line parallel with the optical axis thereof as the at least a part of an element of each of the pair of objective optical systems is moved for focusing.

Further optionally, the displaceable optical elements may be held by a frame member, and the guiding mechanism may include a guide shaft that extends in a direction parallel with the optical axis of the one of the pair of objective optical systems and rotatably and slidably supports the frame holding the optical elements, a guide rail provided to a main body of the binoculars, the guide rail having at least an inclined portion which is inclined with respect to the optical axis of the one of the pair of objective optical systems, and an engagement portion formed on the frame holding the optical elements, the engagement portion engaging with the guide rail. When the engagement portion engages with the inclined portion of the guide rail, the frame holding the optical elements rotates about the guide shaft as the frame holding the optical elements is moved in the direction of the optical axis for focusing.

Optionally, the guide rail has a parallel portion which is parallel to the optical axis of the one of the pair of objective optical systems.

The guide rail may be a groove, a convex line or a gap, integrally provided on the main body.

Further optionally, each of the pair of observation optical system may be configured such that an incidence side optical axis and an emission side optical axis with respect to the erecting optical system are shifted from each other by a predetermined distance, and the binoculars further include a main body that accommodates the pair of objective optical systems, a left barrel containing the left eyepiece optical system and the left erecting optical system, the left barrel being turnable, with respect to the main body, about the left incidence side optical axis of the eyepiece optical system, and a right barrel containing the right eyepiece optical system and the right erecting optical system, the right barrel being turnable, with respect to the main body, about the right incidence side optical axis. With the above configuration, the distance between the emission side optical axes of the pair of eyepiece optical systems is made adjustable by turning the left barrel and right barrel with respect to the main body.

Optionally, the frame member may be provided with a light shielding member that serves to prevent straying light from entering inside the binoculars through a space provided to allow the frame member to move in a direction perpendicular to the optical axis.

Further optionally, the light shielding member may include a partial outer flange member protruded outward from the frame member.

Optionally, the binoculars may further include a partition wall provided between the pair of objective optical systems, the partition wall preventing light from entering the binoculars through a clearance formed between the pair of objective optical systems.

Further optionally, a surface of the partition wall facing the frame member is inclined with respect to the optical axis of the one of the pair of objective optical systems corresponding to an axial movement for focusing and a rotational movement for convergence value compensation.

### BRIEF DESCRIPTION OF THE ACCOMPANYING DRAWINGS

FIG. 1 is a sectional plan view of binoculars according to an embodiment of the invention in an infinity-focused state;

FIG. 2 is a sectional side view of the binoculars according to the embodiment of the invention in an infinity-focused state;

FIG. 3 is a sectional front view of the binoculars according to the embodiment of the invention in an infinity-focused state;

FIG. 4 is a sectional plan view of the binoculars according to the embodiment of the invention in a shortest distance focused state;

FIG. 5 is a sectional side view of the binoculars according to the embodiment of the invention in a shortest distance focused state; and

FIG. 6 is a sectional front view of the binoculars according to the embodiment of the invention in a shortest distance focused state.

### DETAILED DESCRIPTION OF THE EMBODIMENTS

Hereinafter, binoculars according to embodiments of the present invention will be described in detail with reference to the accompanying drawings.

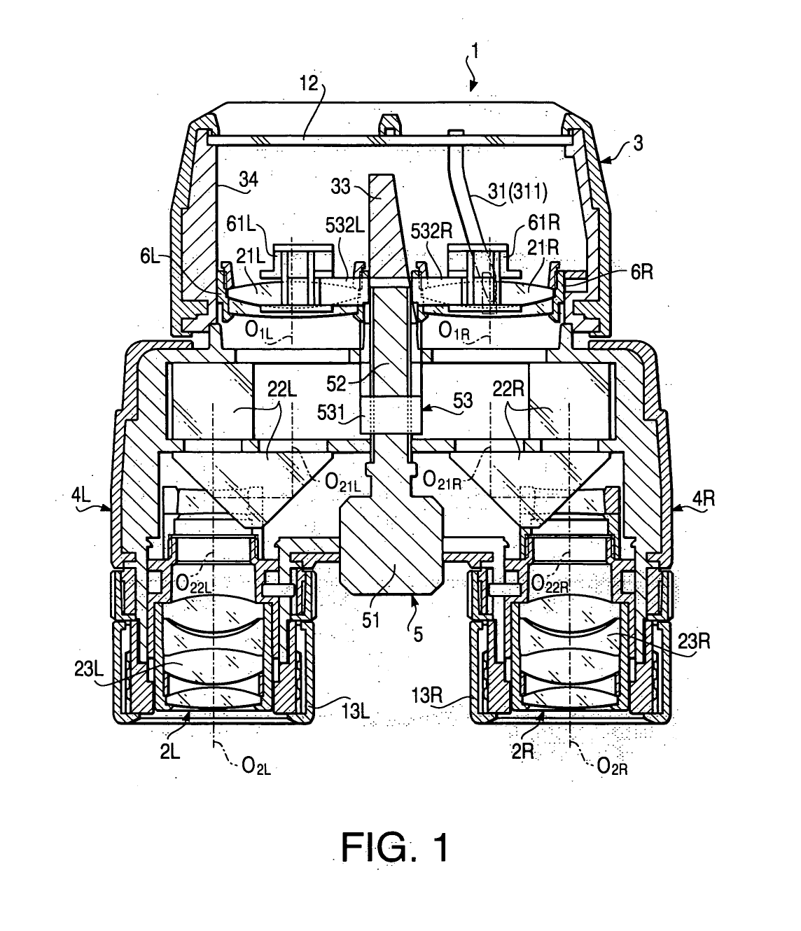

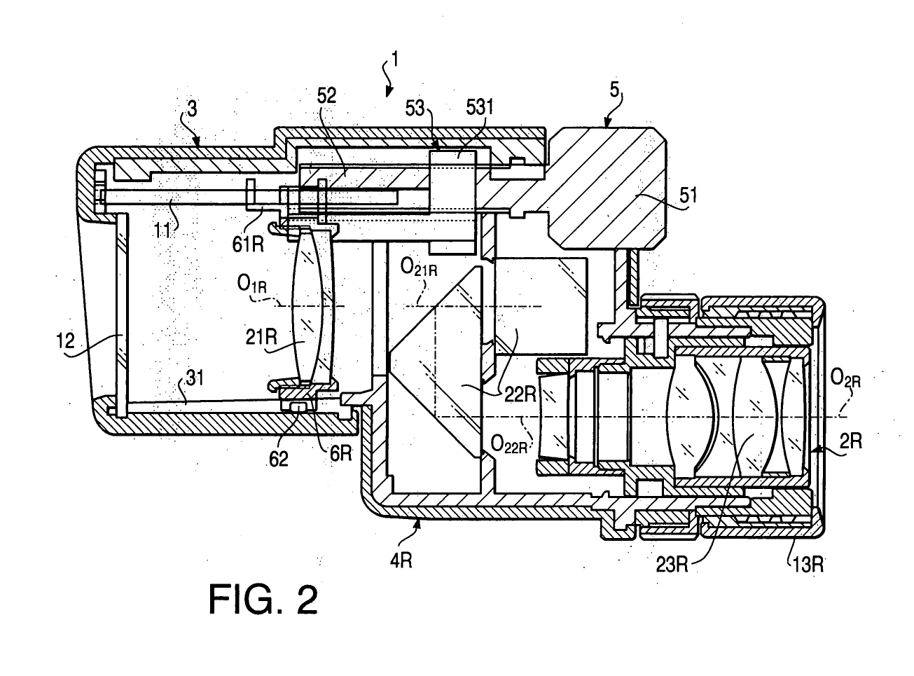

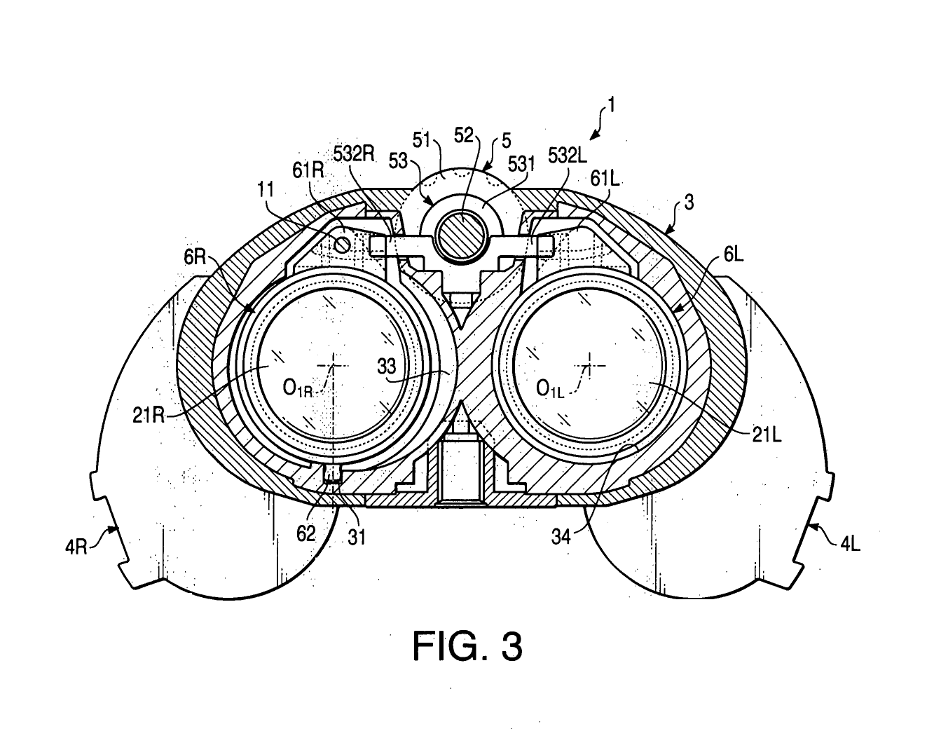

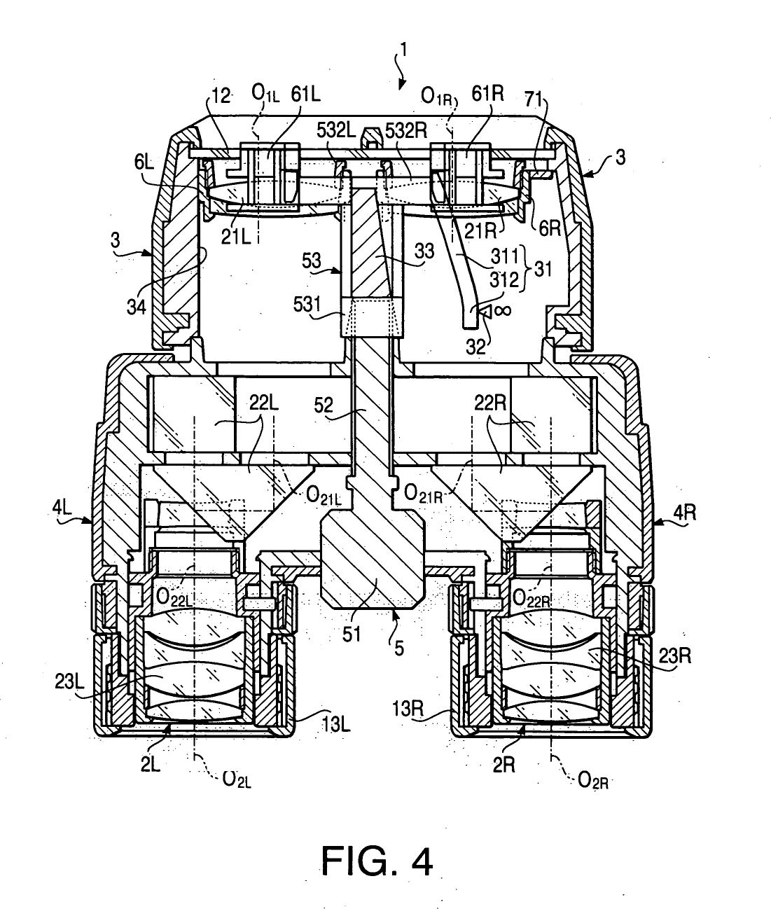

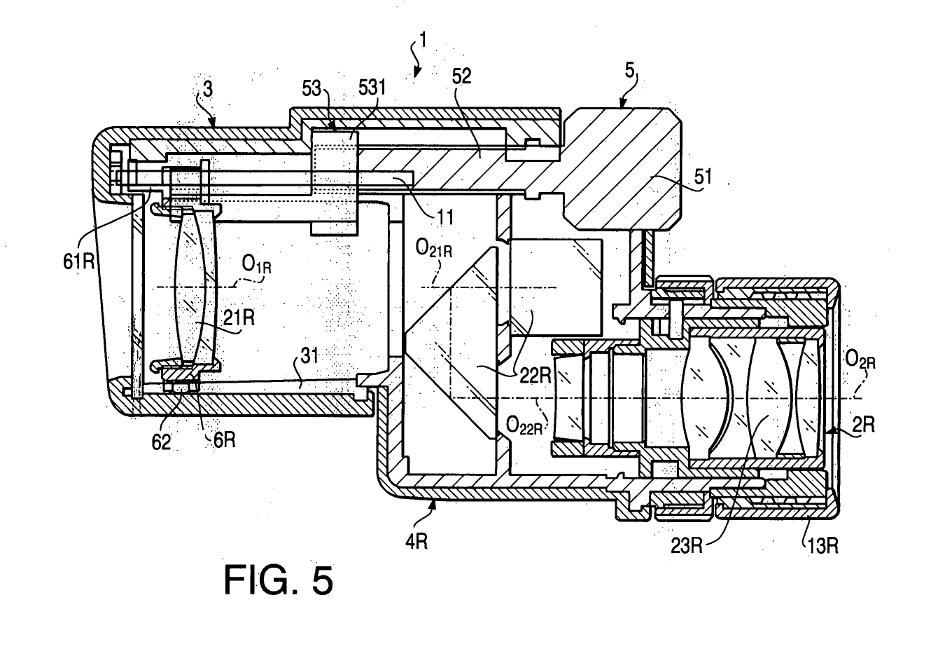

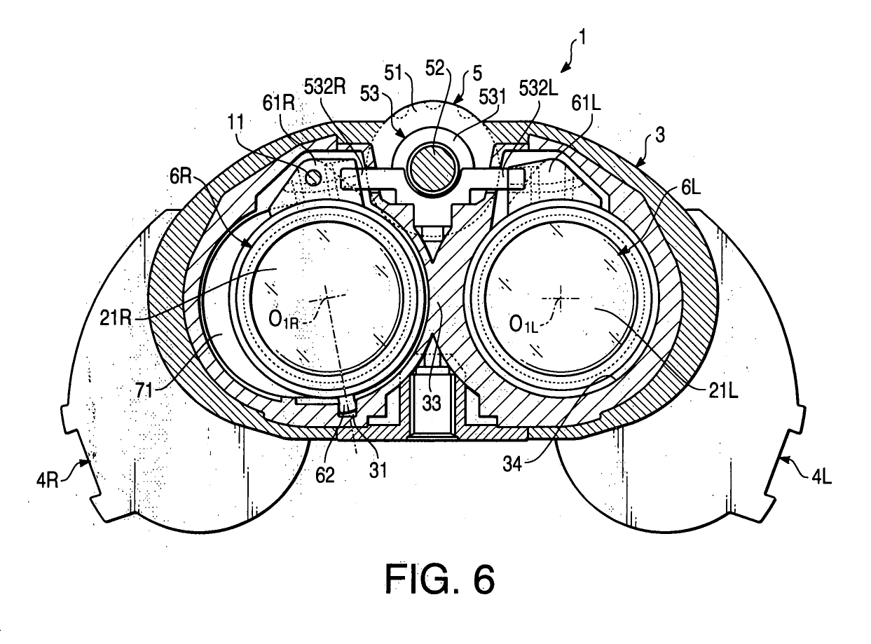

FIG. 1, FIG. 2 and FIG. 3 are cross-sectional plan view, cross-sectional side view and cross-sectional front view of binoculars according to a first embodiment of the invention when the binoculars are focused on an object at infinity (hereinafter, the state will be referred to as the “infinity focused state”). FIG. 4, FIG. 5 and FIG. 6 are sectional plan view, sectional side view and sectional front view when the binoculars according to the embodiment of the invention are focused to an object at its shortest distance (hereinafter, the state will be referred to as the “shortest distance focused state”).

It should be noted that, in this specification, the upper side in FIG. 1 and the left-hand side in FIG. 2 are referred to as a “front” side of the binoculars, the lower side in FIG. 1 and the right-hand side in FIG. 2 are referred to as a “rear” side of the binoculars 1, the upper side in FIG. 2 and FIG. 3 is referred to as the “up or upside” and the lower side therein is referred to as the “down or downside” of the binoculars 1.

As shown in FIG. 1, the binoculars 1 include an observation optical system 2L for the left eye, an observation optical system 2R for the right eye, a main body 3 which is a casing for accommodating the above-described observation optical systems 2L, a left barrel 4L and a right barrel 4R, and a focusing mechanism 5 used for focusing in accordance with an object distance.

The observation optical systems 2L and 2R have objective optical systems 21L and 21R, erecting optical systems 22L and 22R and eyepiece optical systems 23L and 23R, respectively. The erecting optical systems 22L and 22R in the observation optical systems 2L and 2R are composed of Porro prisms, respectively. A predetermined gap (spacing) is formed between the incidence side optical axes O_{21L} and O_{21R} of the eyepiece optical systems 23L and 23R with respect to the erecting optical systems 22L and 22R and the emission side optical axes O_{22L} and O_{22R} thereof. In the infinity focused state, the optical axes O_{1L} and O_{1R} of the objective optical systems 21L and 21R coincide with the incidence side optical axes O_{21L} and O_{21R}, respectively.

Both the objective optical systems 21L and 21R are integrally installed in the main body 3. The left side eyepiece optical system 23L and erecting optical system 22L, and the right side eyepiece optical system 23R and erecting optical system 22R are installed in the left barrel 4L and right barrel 4R which are separated from each other. The main body 3, left barrel 4L and right barrel 4R may be composed of a single part or may be composed of a plurality of combined parts.

The left barrel 4L and right barrel 4R are coupled to the main body 3 so as to turn within a predetermined angular range about the incidence side optical axes O_{21L} and O_{21R}, respectively. Further, the barrels 4L and 4R can be held at any positions within the predetermined angular range by friction.

By turning the left barrel 4L and right barrel 4R in opposite directions, the distance between the optical axes O_{2L} and O_{2R} (distance between the emission side optical axes O_{22L} and O_{22R}) of both the eyepiece optical systems 23L and 23R can be adjusted to meet the width between the eyes of the observer. It is preferable that the binoculars 1 are provided with an interlock mechanism (not illustrated) by which the left barrel 4L and right barrel 4R turn in opposite directions simultaneously with each other.

In the composition as illustrated, a cover glass 12 is provided in the window part opening forward of the main body 3. With this configuration, foreign substances or dusty substances are prevented from entering the main body 3. The cover glass 12 may be omitted.

At the rear end portions of the barrels 4L and 4R, eyepiece members 13L and 13R are secured concentrically with the eyepiece optical systems 23L and 23R, respectively. The eyepiece members 13L and 13R are displaceable in the directions of the optical axes O_{2L} and O_{2R}, that is, movable from the accommodated state shown in FIG. 1 to a state (not illustrated) where the eyepiece members 13L and 13R are drawn rearward. The user adjusts the positions of the eyepiece members 13L and 13R depending on the presence/absence of glasses or facial features, and then looks into the eyepiece optical systems 23L and 23R circumocularly or with his/her glasses abutted against the rearward end surface of the eyepiece members 13L and 13R. With this configuration, the user can place his/her eyes at appropriate eye points (the positions where all the fields of view can be seen without being shielded) in a stable state.

The objective optical systems 21L and 21R are made movable with respect to the main body 3, and are moved by actuation of the focusing mechanism 5.

The objective optical system 21L is held by the lens frame 6. An inner surface 34 of a space of the main body 3, where the lens frame 6 moves has a concave cylindrical shape, An outer surface of the lens frame 6L has a convex cylindrical shape, and the outer surface of the lens frame 6L slidably guided by the inner surface 34, thereby the objective optical system 21L is linearly guided in the direction of the optical axis O_{1L}.

As shown in FIG. 2 and FIG. 3, the main body 3 is provided with a guide shaft 11 and a guide groove (guide rail) 31 for guiding a movement of the objective optical system 21R.

The guide shaft 11 is composed of a straight rod. The guide shaft 11 is arranged on the upper side of the objective optical system 21R, extending in parallel with the optical axes O_{1L} and O_{1R}. As shown in FIG. 3, protruded portion 61R formed on the upside portion of the lens frame 6R for retaining the objective optical system 21R has a hole, through which the guide shaft 11 is inserted. With this configuration, the objective optical system 21R is movable along the guide shaft 11R, and is turnable about the guide shaft 11R.

The guide rail (groove) 31 is a groove formed on the inner wall on the lower side of the main body 3. A projection (engagement portion) 62, which is inserted into the guide groove 31, is formed on a downward portion of the lens frame 6R. As the objective optical system 21R is moved along the guide shaft 11, the projection 62 is moved along the guide groove 31.

As shown in FIG. 3, a cross sectional shape of the guide rail (groove) 31 is substantially rectangular (U-shaped) having inner walls (side walls) which are parallel with each other and extend in an up and down direction of the binoculars 1.

As shown in FIG. 1, the focusing mechanism 5 includes a turning ring (focusing ring) 51 which serves as an operable member, a focusing ring shaft 52 which turns along with the focusing ring 51 and a vane 53. Both the focusing ring 51 and focusing ring shaft 52 are located between the observation optical systems 2L and 2R in the plan view and are rotatably supported on the main body 3. The vane 53 is provided with a base portion 531 having a female thread which is engaged with a male thread formed on the outer circumferential surface of the focusing ring shaft 52. The vane 53 is further provided with arms 532L and 532R protruding leftward and rightward from the proximal portion 531, respectively. The tip end portions of the arms 532L and 532R are inserted into grooves formed in the protruded portions 61L and 61R of the lens frames 6L and 6R.

If the focusing ring 51 is rotated in a predetermined direction, the proximal portion 531 advances along the direction where the focusing ring shaft 52 extends. Then, the force is transmitted to the lens frames 6L and 6R via the arms 532L and 532R to cause the objective optical systems 21L and 21R to protrude forward. If the focusing ring 51 is turned in the direction opposite to the predetermined direction, the objective optical systems 21L and 21R are caused to be retracted rearward. With such actuation of the focusing mechanism 5, focusing can be carried out.

In the infinity focused state shown in FIG. 1 and FIG. 3, the objective optical systems 21L and 21R are in a rearward retracted state (i.e., fully retracted rearward).

To the contrary, in the shortest distance focused state shown in FIG. 4 through FIG. 6, the objective optical systems 21L and 21R are fully protruded forward. The shortest focusing distance of the binoculars 1 can be obtained in this state. The shortest focusing distance is not limited to a specific value. However, as described below, since the binoculars 1 according to the invention are provided with a convergence value compensation mechanism and are suitable for short distance observation, it is preferable that the shortest focusing distance is relatively short in comparison with conventional binoculars, which distance is, for example, 0.3 m through 1 m in range.

The binoculars 1 are provided with a convergence value compensation mechanism for compensating for the convergence value by varying the distance between the optical axes Ohd 1L and O_{1R} of the objective optical systems 21L and 21R in association with the operation of the focusing mechanism 5. In the embodiment, the convergence value compensation mechanism includes the guide shaft 11, the guide rail (groove) 31 and the projections 62 as described above. Hereinafter, a description is given of compensation for the convergence value in the binoculars 1 according to the first embodiment.

As shown in FIG. 4, the guide rail (groove) 31 is provided with an inclined portion 311 extending along a direction inclined with respect to the optical axes O_{1L} and O_{1R} of the objective optical systems 21L and 21R, and a parallel portion 312 continuously formed rearward of the inclined portion 311 and extending in parallel to the optical axes O_{1L} and O_{1R}. The inclined portion 311 is inclined such that the inclined portion 311 becomes closer to the center of the binoculars 1. A marker 32 indicating the position of the objective optical system 21R in the infinity focused state is provided sideward at a predetermined position along the parallel portion 312.

When the projection 62 is located at the parallel portion 312, even if the focusing mechanism 5 is operated and the objective optical systems 21L and 21R are moved, the distance between the optical axes Ohd 1L and O_{1R} does not change. That is, no convergence value compensation is effected in the vicinity of the infinity focused state. It is because, when observing an object at a relatively far distance, the convergence value correction is unnecessary.

When the projection 62 is located at the inclined portion 311, as the focusing mechanism 5 is operated and objective optical systems 21L and 21R is advanced, the projection 62 approaches the center along the inclined portion 311. Thus, the objective optical system 21R is rotated about the guide shaft 11, and the distance between the optical axes O_{1L} and O_{1R} is gradually reduced, thereby the convergence value being compensated for (see FIG. 3 and FIG. 6).

Since the convergence value is compensated as described above, a difference between an image observed by the left eye and an image observed by the right eye when observing a short distance object can be prevented, and the observation becomes easy and comfortable.

Although there is no special limitation with respect to the focusing distance (adjustment value) at which convergence value compensation is effected, it is preferable that the distance is 3 m through 5 m. The boundary point between the inclined portion 311 and the parallel portion 312 in the guide rail 31 is set at a position corresponding to the focusing distance at which the convergence value compensation is effected.

The binoculars 1 according to the embodiment is provided with a light shielding plate 71 and a partition wall 33, which prevent light (straying light) from entering inside the binoculars through a clearance which is formed as the objective optical system 21R is displaced for the convergence compensation.

As shown in FIG. 4, the light shielding plate 71 is provided to the lens frame 6R such that it protrudes outward at the right-hand portion in FIG. 4 as a partial flange. The light shielding plate 71 is displaced in association with the objective optical system 21R. As shown in FIG. 6, when viewed along the optical axis of the objective optical system 21R, the light shielding plate 71 is substantially crescent-shaped. When the objective optical system 21R is moved forward for focusing, a clearance is formed on the outer side of the objective optical system 21R. The light shielding plate 71 serves to prevent straying light from entering through the clearance.

As shown in FIG. 1, the partition wall 33 is provided inside the main body 3 such that a space allowing the left optical system 21L (i.e., the lens frame 6L) and a space allowing the right optical system 21R (i.e., the lens frame 6R) are separated. A right-hand side surface (see FIG. 1) of the partition wall 33 is inclined such that a front portion is closer to the center of the main body 3 and rear portion thereof is farther from the center. The partition wall 33 serves to prevent the straying light from entering through the clearance formed on the inner side of the objective optical system 21R when it is retracted to the rear side.

According to the embodiment described above, since the light shielding plate 71 and the partition wall 33 are provided, the straying light can be well shielded and generation of a flare can be prevented. Therefore, an effect of the straying light (e.g., lowering the contrast of the image to be observed) can be prevented, and the observation images can be maintained in a good condition.

As described above, the binoculars 1 is configured such that the right-side objective optical system 21R is rotated about the guide shaft 11 to that it moves in a direction perpendicular to its optical axis O1R in order to compensate for the convergence. On the other hand, the left-side objective optical system 21L does not move in the direction perpendicular to its optical axis O1L for the convergence compensation.

As above, according to the embodiment, only one convergence compensation mechanism (which includes the guide shaft 11, the guide groove 31 and the projection 62) is provided only one of the objective optical systems, and such a convergence compensation mechanism is not provided to the other objective optical system. Accordingly, the structure of the binoculars 1 can be simplified, the number of elements can be reduced, and the manufacturing cost can be reduced.

Further, according to the embodiment, only one convergence compensation mechanism is provided to one of the pair of objective optical systems (e.g., the optical system 21R). Therefore, the number of moving parts can be reduced, and the convergence compensation can be performed at a higher accuracy. Further, the disorder would occur less frequently even if the binoculars are used for years.

According to the conventional binoculars, it is necessary that the convergence compensation mechanisms for the respective objective optical systems should be displaced exactly synchronously with each other, and it has been difficult to retain the high accuracy for the mechanism. According to the embodiment described above, since only one objective lens is moved, the problems as in the conventional binoculars will not arise, and the convergence compensation can be performed at a high accuracy.

According to the embodiment, by employing a structure for rotating one of the objective optical systems to change a distance between the optical axes O1R and O1L of the objective optical systems 21R and 21L, the structure of the mechanism can be simplified, which reduces the manufacturing cost.

It should be noted that the invention need not be limited to the above-described exemplary embodiment, but can be modified in various ways without departing from the scope of the invention.

In the above-described embodiment, the convergence compensation is carried out by moving the right objective optical system. It is possible to move the left objective system instead of the right objective optical system.

In the embodiments described above, the objective optical system is composed of one lens group including two lenses, and focusing and convergence compensation are carried out by moving the entirety of one of the objective optical system. However, the invention need not be limited to such an objective optical system and can be modified. For example, if he objective optical systems is composed of more than one lens groups, the convergence compensation may be carried out by moving a part of the lens groups constituting the objective optical system. It should further be noted that the focusing can be carried out by moving optical elements which are included in an optical system other than the objective optical system.

In the above embodiment, the convergence compensation is carried out by rotating one of the objective optical systems. The invention need not be limited to such a configuration, and, for example, it is possible to translate one of the objective optical systems in a direction perpendicular to its optical axis to vary the distance between the optical axes of the objective optical axes.

Alternatively, it is possible to incline the optical axis of one of the objective optical systems to compensate for the convergence value.

It should be noted that the guide rail may be a groove as in the above-described embodiment may be replaced with a convex line or a gap, integrally provided on the main body.

The present invention can be applied to not only the binoculars described above but also roof prism binoculars in which the distance between the optical axes of the eyepiece optical systems are equal to the distance between the optical axes of the objective optical systems. Further, the present invention can be applied binoculars such as Zeis type or Bausch and Lomb type binoculars in which the distance between the optical axes of the eyepiece optical systems are greater that the distance between the optical axes of the objective optical systems.

The present disclosure relates to the subject matter contained in Japanese Patent Application No. 2004-125911, filed on Apr. 21, 2004, which is expressly incorporated herein by reference in its entirety.

1. Binoculars, comprising:
a pair of observation optical systems each having an objective optical system, an erecting optical system and an eyepiece optical system;
a focusing mechanism that moves a part of each of observation optical systems;
a convergence value compensating mechanism that operates in association with operation of the focusing mechanism, the convergence value compensating mechanism moving displaceable optical elements which are at least a part of one of the pair of objective optical systems to compensate for the convergence value, optical elements of the other one of the pair of objective optical systems being unmoved for varying the convergence value.

2. The binoculars according to claim 1,
wherein the convergence value compensating mechanism moves the displaceable optical elements such that a distance between an optical axis of one of the pair of objective optical systems and the other one of the pair of objective optical systems varies in association with the movement of the part of each of observation optical systems for focusing.

3. The binoculars according to claim 2,
wherein the convergence value compensating mechanism rotates the optical elements about a line parallel with the optical axis thereof to vary the distance between the optical axis of the optical element and an optical axis of the other one of the pair of objective optical systems.

4. The binoculars according to claim 3,
wherein the focusing mechanism moves at least a part of an element of each of the pair of objective optical systems for focusing; and
wherein the convergence compensating mechanism is provided with a guiding mechanism that guides the movement of the displaceable optical elements to rotate about the line parallel with the optical axis thereof as the at least a part of an element of each of the pair of objective optical systems is moved for focusing.

5. The binoculars according to claim 4,
wherein the displaceable optical elements are held by a frame member,
wherein the guiding mechanism includes:
a guide shaft that extends in a direction parallel with the optical axis of the one of the pair of objective optical systems and rotatably and slidably supports the frame holding the displaceable optical elements;
a guide rail provided to a main body of the binoculars, the guide rail having at least an inclined portion which is inclined with respect to the optical axis of the one of the pair of objective optical systems; and
an engagement portion formed on the frame holding the displaceable optical elements, the engagement portion engaging with the guide rail,
wherein, when the engagement portion engages with the inclined portion of the guide rail, the frame holding the displaceable optical elements rotates about the guide shaft as the frame holding the optical elements is moved in the direction of the optical axis for focusing.

6. The binoculars according to claim 5, wherein the guide rail has a parallel portion which is parallel to the optical axis of the one of the pair of objective optical systems.

7. The binoculars according to claim 5, wherein the guide rail is one of a groove, a convex line and a gap, integrally provided on the main body.

8. The binoculars according to claim 1,
wherein each of the pair of observation optical system is configured such that an incidence side optical axis and an emission side optical axis with respect to the erecting optical system are shifted from each other by a predetermined distance,
wherein the binoculars further include:
a main body accommodating the pair of objective optical systems;
a left barrel containing the left eyepiece optical system and the left erecting optical system, the left barrel being turnable, with respect to the main body, about the left incidence side optical axis; and
a right barrel containing the right eyepiece optical system and the right erecting optical system, the right barrel being turnable, with respect to the main body, about the right incidence side optical axis, and
wherein the distance between the emission side optical axes is made adjustable by turning the left barrel and right barrel with respect to the main body.

9. The binoculars according to claim 5,
wherein the frame member is provided with a light shielding member that serves to prevent straying light from entering inside the binoculars through a space provided to allow the frame member to move in a direction perpendicular to the optical axis.

10. The binoculars according to claim 9,
wherein the light shielding member includes a partial outer flange member protruded outward from the frame member.

11. The binoculars according to claim 9, further including a partition wall provided between the pair of objective optical systems, the partition wall preventing light from entering the binoculars through a clearance formed between the pair of objective optical systems.

12. The binoculars according to claim 11,
wherein a surface of the partition wall facing the frame member is inclined with respect to the optical axis of the one of the pair of objective optical systems corresponding to an axial movement for focusing and a rotational movement for convergence value compensation.
